(19) United States
(12) Patent Application Publication
(10) Pub. No.: US 2018/0173032 A1
(43) Pub. Date: Jun. 21, 2018

(54) METHOD OF PRODUCING DISPLAY DEVICE, AND DISPLAY DEVICE

(71) Applicant: SHARP KABUSHIKI KAISHA, Sakai City, Osaka (JP)

(72) Inventors: KATSUYUKI SUGA, Sakai City (JP); YASUMORI FUKUSHIMA, Sakai City (JP)

(73) Assignee: SHARP KABUSHIKI KAISHA, Sakai City, Osaka (JP)

(21) Appl. No.: 15/736,741

(22) PCT Filed: Jun. 9, 2016
(86) PCT No.: PCT/JP2016/067167

§ 371 Date: Dec. 14, 2017

(30) Foreign Application Priority Data
Jun. 16, 2015 (JP) 2015-121149

(51) Int. Cl. G02F 1/1339; G02F 1/1362; G02F 1/1345; G02F 1/1335; G09G 3/34

(52) U.S. Cl. CPC G02F 1/1339; G02F 1/136286; G02F 1/13452; G02F 1/1368; G02F 1/133514; G09G 3/3406; G02F 2201/52; G02F 1/133512

(57) ABSTRACT

A method includes a recess forming process of forming a recess in a part of a first substrate, a resin film forming process of forming a resin film having flexibility within the recess, a metal line forming process of forming metal lines continuously on another part of the first substrate and the resin film, a pattern forming process of forming thin film patterns on the other part of the first substrate, a bonding process of disposing sealant the first substrate to surround the thin film patterns and bonding the first substrate and a second substrate, a second substrate removing process of removing a section of the second substrate outside the sealant, and a first substrate removing process of separating and removing at least a section of the first substrate outside the sealant from the resin film.

### TECHNICAL FIELD

The present invention relates to a method of producing a display device, and a display device.

### BACKGROUND ART

In a display panel such as a liquid crystal panel included in a display device, a technology for connecting a flexible circuit board having flexibility to an outer frame portion of a substrate included in the display panel has been known. The flexible circuit board is connected to the outer frame portion to supply driving signals or power to the display panel. Generally, in a method of producing a display device, after a pair of substrates of the display panel are bonded to each other with a sealant, such a flexible circuit board disposed on and connected to an outer frame portion of one of the substrates via an anisotropic conductive film (ACF). A liquid crystal display device including a flexible circuit board that is connected to the substrate of the display panel via the ACF is disclosed in Patent Document 1.

### RELATED ART DOCUMENT

### Patent Document

Patent Document 1: Unexamined Japanese Patent

Application Publication No. 2009-128779

### Problem to be Solved by the Invention

However, in the liquid crystal display device disclosed in Patent Document 1, the liquid crystal panel includes a silicon substrate and a transparent substrate that are bonded to each other with a sealant, and a connection area (a mounting area) for connecting the flexible circuit board is provided on a part of the silicon substrate and outside the sealant so as to be projected from the transparent substrate. The flexible board is connected to the silicon substrate with thermocompression bonding and therefore, the connection area of the flexible circuit board necessarily has a width of approximately 1 mm to 2 mm. Therefore, in a configuration that the silicon substrate has the mounting area for the flexible circuit board outside the sealant, the frame width of the display device is increased by the mounting area and a narrow frame of the display device is less likely to be achieved.

### DISCLOSURE OF THE PRESENT INVENTION

The present invention was made in view of the above circumstances. An object is to achieve a narrow frame in a display device.

### Means for Solving the Problem

A technology described in this specification is related to a method of producing a display device including a recess forming process of forming a recess in one section of a first substrate, a resin film forming process of forming a resin film having flexibility within the recess after the recess forming process, a metal line forming process of forming metal lines continuously on another section of the first substrate and the resin film after the resin film forming process, a pattern forming process of forming thin film patterns on the other section of the first substrate, a bonding process of disposing sealant on the first substrate to surround the thin film patterns and bonding the first substrate and a second substrate opposite each other with the sealant after the pattern forming process, a second substrate removing process of removing a section of the second substrate outside the sealant after the bonding process, and a first substrate removing process of separating and removing at least a section of the first substrate outside the sealant from the resin film after the bonding process.

In the above method of producing a display device, the thin film patterns are formed in the other section of the first substrate in the pattern forming process. When forming thin film transistors with thin film patterns, the sections of the metal lines formed in the other section of the first substrate are configured as the gate electrodes of the thin film transistors. In the metal line forming process, the metal lines are formed to continue from the other section of the first substrate to the resin film. The resin film formed in the section of the first substrate in the resin film forming process is configured as the flexible circuit board for transmitting the signals for driving the produced display device. According to the method, the flexible circuit board is connected onto the first substrate without press-bonding one end of the flexible circuit board onto the first substrate.

The bonding process is performed after the other processes. When one end of the flexible circuit board that is disposed in the recess is connected to the first substrate as a connecting section, the sealant can be applied such that the connecting section is located inside the sealant or near the sealant (including apposition overlapping the sealant in the thickness direction of the first substrate). In the second substrate removing process and the first substrate removing process, large sections of the first substrate and the second substrate outside the sealant can be removed without maintaining mounting areas for mounting the flexible circuit board outside the sealant as in the known technology. In comparison to the known liquid crystal display device including the mounting area for mounting the flexible circuit board outside the sealant, the frame width of the liquid crystal display device can be reduced.

In the above method of producing a display device, in the resin film forming process, the resin film may be formed within the recess such that an upper surface of the first substrate is flush with an upper surface of the resin film.

If a difference in level is created between the upper surface of the first substrate and the upper surface of the resin film, adjustment of the distance between the first substrate and the second substrate may become difficult in the bonding process. This may create a difference between a forming condition of the metal lines formed on the upper surface of the first substrate and the metal lines formed on the upper surface and the forming of the metal lines may become difficult. In the above method, the resin film is formed in the resin film forming process such that the upper surface of the first substrate is flush with the upper surface of the resin film. Therefore, the above-described problems are less likely to be caused.

The method of producing a display device may further include a folding process of folding at least a section of the resin film projecting outside the recess toward an opposite side from the second glass substrate after the first substrate removing process, and in the folding process, the section of the resin film may be folded while providing a gap between an end surface of the first substrate and a folded section of the resin film.

According to such a method, in the folding process, the section of the resin film outside the recess is folded to have the gap. Accordingly, the end surface of the first substrate and the folded section of the resin film do not contact each other because of the gap. Therefore, the folded section of the flexible circuit board is less likely to be damaged by the end surface of the first substrate.

In the above method of producing a display device, in the folding process, the section of the resin film may be folded such that the folded section of the resin film overlaps the sealant in a thickness direction of the first substrate.

According to such a method, the folded section of the resin film does not project outward from the sealant after the folding process, and the display device including a frame of a further reduced frame width is produced.

In the method of producing a display device, in the recess forming process, a projection portion projecting in a thickness direction of the first substrate may be formed within the recess, and in the resin film forming process, a through hole through which the projection portion is inserted may be formed in a part of the resin film.

According to such a method, the projection portion is inserted through the through hole and accordingly, the resin film is stopped by the projection portion. Therefore, the resin film is less likely to be detached from the recess in a direction crossing a direction in which the projection portion is projected. Thus, holding strength of the first substrate with the resin film can be increased.

In the method of producing a display device, in the recess forming process, the recess may be formed along an entire periphery of an edge of the first substrate.

According to such a method, the resin film is formed in a frame shape along an outer edge of the first substrate. Therefore, the resin film is less likely to be removed from the recess in a plate surface direction of the first substrate. Thus, the holding strength of the first substrate with the resin film can be increased.

Another technology described in this specification is related to a display device including a display panel including substrates in a pair that are bonded with sealant, the display panel performing displaying, a flexible circuit board having flexibility and a section of which is disposed in one of the substrates, the section disposed in the one substrate including a portion overlapping the sealant in a thickness direction of the substrates between the substrates, and metal lines formed continuously on the one substrate and the flexible circuit board and through which signals for driving the display panel are transmitted.

In the above display device, the metal lines are formed continuously on the one substrate and the flexible circuit board and driving signals and power can be supplied to the display panel through the flexible circuit board. At least a part of the section of the flexible circuit board disposed in the one substrate overlaps the sealant between the substrates in the thickness direction of the substrates. Therefore, the flexible circuit board is connected to the display panel at a position overlapping the sealant or at a position inside the sealant. Therefore, mounting areas for mounting the flexible circuit board is not necessary to be provided outside the sealant and in comparison to the known display device including the mounting area for mounting the flexible circuit board outside the sealant, the frame width of the display device can be reduced.

In the above display device, the display panel may include a display area and a non-display area within a panel surface area, the display area displaying images and the non-display area displaying no images, and the section of the flexible circuit board disposed in the one substrate may be in only a section of the flexible circuit board overlapping the non-display area in a thickness direction of the substrates.

If a section of the flexible circuit board made of opaque material overlaps the display area of the display panel, a display failure may occur in the overlapping area. If the material of the flexible circuit board is transparent material, display quality of display images may be deteriorated in the overlapping area according to the optical properties of the resin film. In the above configuration, the flexible circuit board is disposed only in a portion overlapping the non-display area, and therefore such a display failure or degradation in display quality is less likely to occur.

In the above display device, the display panel may include a display area and a non-display area within a panel surface area, the display area displaying images and the non-display area displaying no images, the display device may further include a controller configured to control brightness of the images on the display area, the other substrate may include a light blocking section that has light blocking properties and is formed in a grid and color sections that are formed in sections surrounded by the light blocking section, and the color sections formed in the sections may have different colors, and a combination of the color sections of different colors may form a display pixel, a most inner-side portion of the section of the flexible circuit board that is disposed in the recess may overlap a most outer edge-side one of display pixels within the display area in the thickness direction of the substrates, and the controller may include a correcting section configured to correct the images such that the display pixels on the outermost side within the display area are displayed brighter than other display pixels.

If the flexible circuit board is made of opaque material and a part of the flexible circuit board overlaps the display area of the display panel, a display failure may be caused in an image displayed on an overlapping area of the display panel. However, even if brightness is different between the display pixels disposed on the outermost side within the display area and other display pixels, such brightness difference is less likely to be recognized. According to the above configuration, even if the flexible circuit board is made of opaque material, the correcting section controls the display pixels disposed on the outermost side to be displayed brighter than the other display pixels. Therefore, brightness difference between the display pixels disposed on the outermost side and other display pixels is less likely to be recognized.

The most inner-side portion of the section of the flexible circuit board that is disposed in the recess overlaps the most outer edge-side display pixels within the display area. Such a configuration can be achieved no matter what the material of the flexible circuit board is, and with the above configuration, brightness difference is less likely to be produced between the display pixels disposed on the outermost side and other display pixels, that is, display failures are less likely to be caused in the displayed images. As a result, most part of the flexible circuit board can be disposed in the recess and the holding strength of the one substrate with the flexible circuit board can be increased. If the sealant has a reduced width, the section of the flexible circuit board that is disposed in the recess has a sufficient width such that a frame of the display device can be narrower.

### Advantageous Effect of the Invention

According to the present invention, a narrow frame is achieved in a display device.

### BRIEF DESCRIPTION OF THE DRAWINGS

FIG. 1 is a schematic plan view of a liquid crystal display device according to a first embodiment.

FIG. 2 is a schematic cross-sectional view of a liquid crystal panel illustrating a cross-sectional configuration along line II-II in FIG. 1.

FIG. 3 is a magnified cross-sectional view of the liquid crystal panel illustrating a connection portion of a flexible circuit board.

FIG. 4 is a cross-sectional view illustrating process (1) of a method of producing the liquid crystal display device according to the first embodiment.

FIG. 5 is a cross-sectional view illustrating process (2) of a method of producing the liquid crystal display device according to the first embodiment.

FIG. 6 is a cross-sectional view illustrating process (3) of the method of producing the liquid crystal display device according to the first embodiment.

FIG. 7 is a cross-sectional view illustrating process (4) of the method of producing the liquid crystal display device according to the first embodiment.

FIG. 8 is a cross-sectional view illustrating process (5) of the method of producing the liquid crystal display device according to the first embodiment.

FIG. 9 is a cross-sectional view illustrating process (6) of the method of producing the liquid crystal display device according to the first embodiment.

FIG. 10 is a cross-sectional view illustrating process (7) of the method of producing the liquid crystal display device according to the first embodiment.

FIG. 11 is a schematic cross-sectional view of a liquid crystal panel according to a second embodiment.

FIG. 12 is a schematic cross-sectional view of a liquid crystal panel according to a modification of the second embodiment.

FIG. 13 is a magnified cross-sectional view of a liquid crystal panel illustrating a connection portion of a flexible circuit board according to a third embodiment.

FIG. 14 is a schematic cross-sectional view of a liquid crystal panel according to a modification of the third embodiment.

FIG. 15 is a schematic cross-sectional view of a liquid crystal panel according to a fourth embodiment.

FIG. 16 is a schematic cross-sectional view of a liquid crystal panel illustrating a cross-sectional configuration along line XVI-XVI in FIG. 15.

FIG. 17 is a schematic cross-sectional view of a liquid crystal panel according to a modification of the fourth embodiment.

FIG. 18 is a schematic plan view typically illustrating a flexible circuit board and color filters that are overlapped with each other in a liquid crystal panel according to a fifth embodiment.

FIG. 19 is a schematic cross-sectional view of a liquid crystal panel illustrating a cross-sectional configuration along line XIX-XIX in FIG. 18.

FIG. 20 is a block diagram illustrating an electrical configuration of a liquid crystal display device according to the fifth embodiment.

### MODES FOR CARRYING OUT THE INVENTION

### First Embodiment

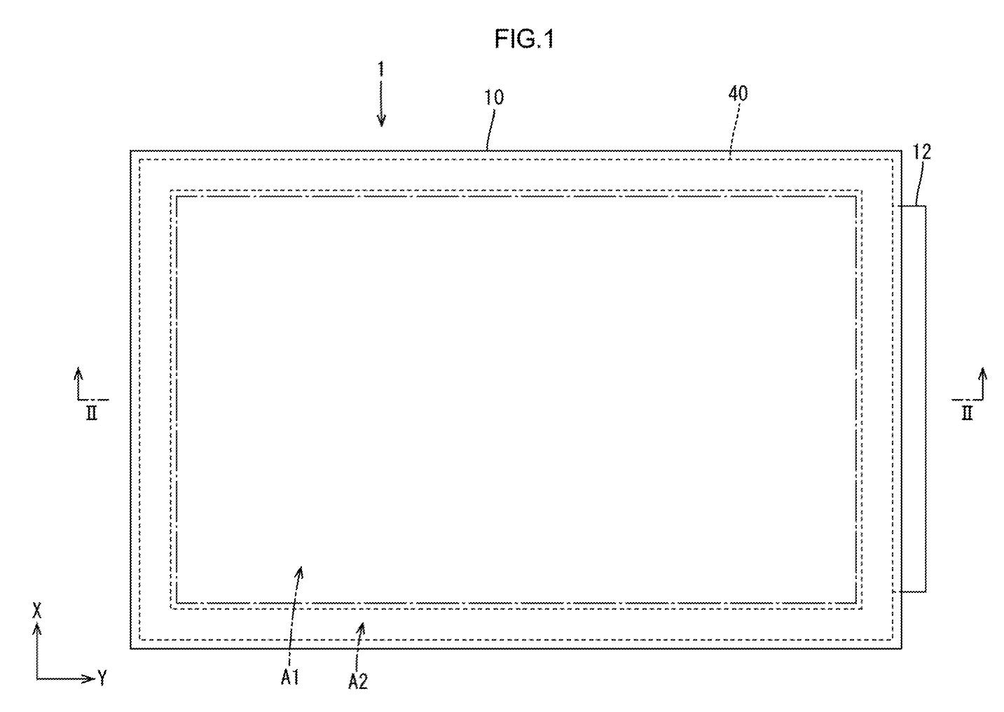

A first embodiment of the present invention will be described with reference to FIGS. 1 to 10. In this section, a method of producing a liquid crystal display device 1 (an example of a display device) will be described. X-axes, Y-axes, and Z-axes may be provided in the drawings. The axes in each drawing correspond to the respective axes in other drawings to indicate the respective directions. An upper side in in each cross-sectional view corresponds to an upper side (a front side) of the liquid crystal display device 1.

First, a configuration of the liquid crystal panel 1 and a configuration of a liquid crystal panel 10 will be described. As illustrated in FIG. 1, the liquid crystal display device 1 described in this section includes the liquid crystal panel 10 (an example of a display panel) and a backlight unit (not illustrated). The liquid crystal panel 10 has a rectangular shape in a plan view. The backlight unit is mounted in the back side portion of the liquid crystal panel 10 and configured to supply light to the liquid crystal panel 10. A large section of the liquid crystal panel 10 is configured as a display area A1 (an area defined by a chain line in FIG. 1). The display area A1 is a horizontally-long area in which images are displayed. A frame-shaped section outside the display area A1 is configured as a non-display area A2 in which images are not displayed. The frame-shaped non-display area A2 is a frame section of the liquid crystal panel 10.

A first end of a flexible circuit board 12 (an example of a resin film) is connected to a first end of the liquid crystal panel 10 In the Y-axis direction (on the right side in FIG. 1). The flexible circuit board 12 is folded to the backside of the backlight unit. A second end of the flexible circuit board 12 is connected to a control circuit board, which is not illustrated. An IC chip, which is not illustrated, is mounted on the control circuit board. The IC chip is an electronic component for driving the liquid crystal panel 10. The control circuit board is a circuit board for supplying various kinds of input signals to the IC chip. The flexible circuit board 12 has flexibility. The flexible circuit board 12 is made of yellow opaque resin material containing polyimide as a main component. The flexible circuit board 12 is a circuit board that connects the control circuit board and the IC chip to the liquid crystal panel 10 for transmitting the signals from the IC chip to the liquid crystal panel 10.

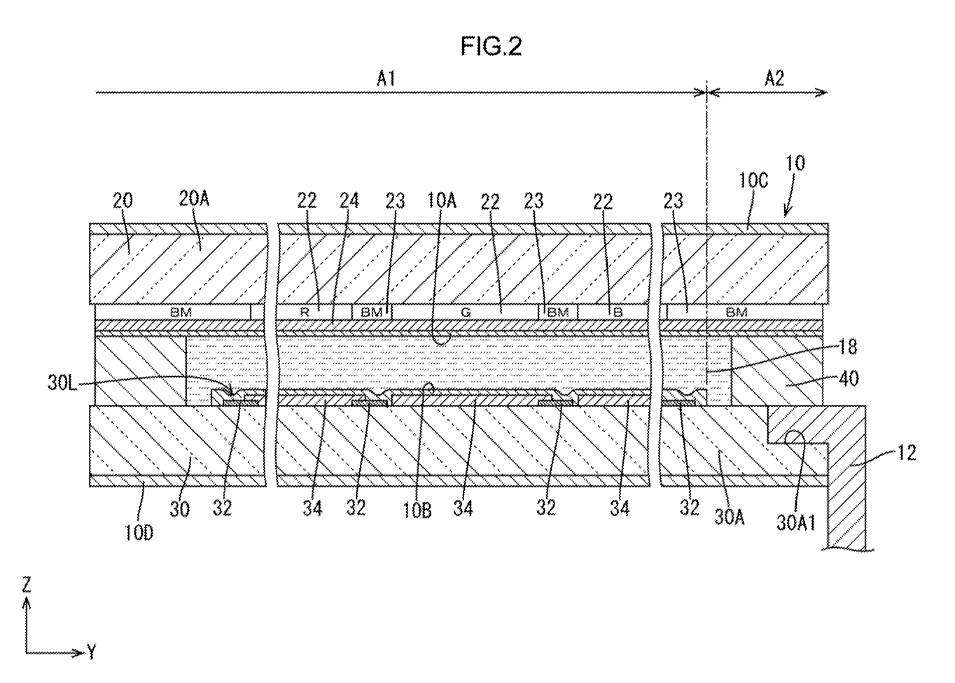

A driving type of the liquid crystal panel 10 is a twisted nematic (TN) type. As illustrated in FIGS. 1 and 2, the liquid crystal panel 10 includes a pair of glass boards 20 and 30 having high light transmissivity and a liquid crystal layer including liquid crystal molecules. The liquid crystal molecules are substances having optical characteristics that change according to an application of an electrical field. The boards 20 and 30 of the liquid crystal panel 10 are bonded together with a cell gap corresponding to a thickness of the liquid crystal layer 18 with an ultraviolet curable type sealant 40. The sealant 40 is in a form of rectangle along outlines of the boards 20 and 30 to surround the liquid crystal layer 18 and thigh film patterns 30L. The first end of the flexible circuit board 12 (the end connected to the liquid crystal panel 10) is disposed in a recess 30A, which will be described later, to overlap a section of the sealant 40 in the thickness direction of the boards 20 and 30 (the Z-axis direction) of the liquid crystal panel 10. The first end of the flexible circuit board 12 is disposed in a section overlapping only the non-display area A2 of the liquid crystal panel 10 in the Z-axis direction.

The one of the boards 20 and 30 of the liquid crystal panel 10 on the front side is the color filter board 20 (an example of a substrate) and the other on the rear side (the back side) is the array board 30 (an example of a substrate). The color filter board 20 and the array board 30 have dimensions in the X-axis direction about equal to each other and dimensions in the Y-axis direction about equal to each other. Alignment films 10A and 10B for orienting the liquid crystal molecules in the liquid crystal layer 18 are formed on inner surfaces of the boards 20 and 30, respectively. Polarizing plates 10C and 10D are attached to an outer surface of a first glass substrate 20A (an example of a second substrate) included in the color filter board 20 and an outer surface of a second glass substrate 30A (an example of a first substrate) included in the array board 30, respectively.

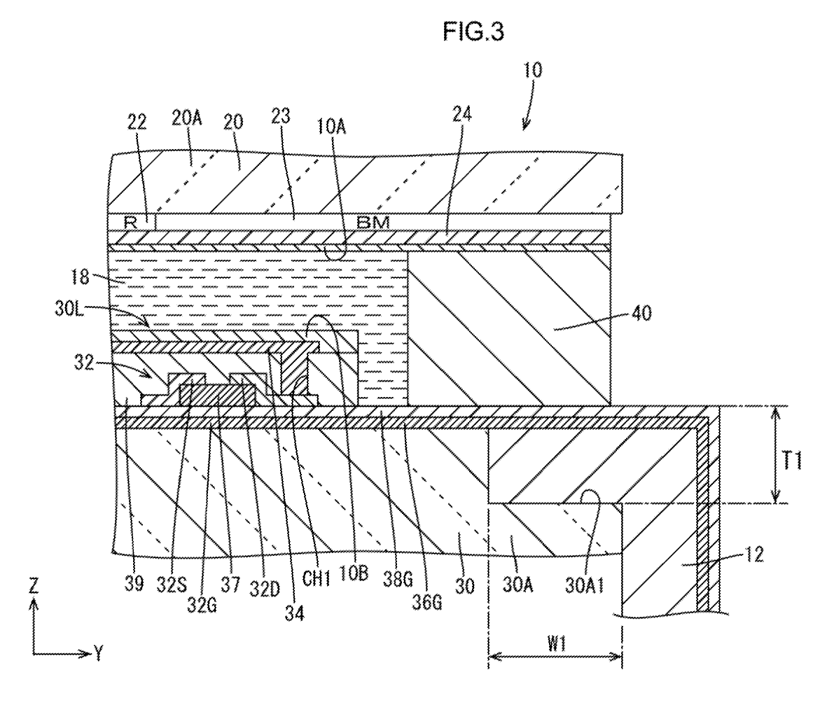

The second glass substrate 30A includes a recess 30A1 at an end in the Y-axis direction (on the right side in FIGS. 1 to 3). The recess 30A1 has openings in the upper surface and the outer surface (the right side in FIGS. 1 to 3). The first end of the flexible circuit board 12 is disposed in the recess 30A1. The flexible circuit board 12 is folded to project downward from the opening. A section of the flexible circuit board 12 inside the recess 30A1 (see FIG. 3) has a width W1 (see FIG. 3) about a few tens of micrometers. In this embodiment, the folded section of the flexible circuit board 12 contacts an end surface of the second glass substrate 30A. The flexible circuit board 12 is disposed in the recess 30A1 such that the upper surface of the flexible circuit board 12 is flush with the upper surface of the second glass substrate 20A except for the recess 30A1. Namely, the thickness of the flexible circuit board 12 is about equal to the depth of the recess 30A1.

The thin film patterns 30L are formed on the inner surface of the second glass substrate 30A (on the liquid crystal layer 18 side) of the array board 30. The thin film patterns 30L include multiple thin film patterns in layers. Specifically, the thin film patterns 30L include thin film patterns of TFTs 32 that are switching components and thin film patterns of pixel electrodes 34. The thin film patterns of pixel electrodes 34 are transparent electrode films such as indium tin oxide (ITO) films. The pixel electrodes 34 are connected to the TFTs 32 and arranged in a matrix in a plan view. Gate lines 36G and source lines are routed in a grid to surround the TFTs 32 and the pixel electrodes 34. Capacitive lines that extend parallel to the gate lines 36G are also routed around the TFTs 32 and the pixel electrodes 34.

The gate lines 36G are metal lines formed from a metal film and patterned on the second glass substrate 30A. The source lines are metal lines formed from a metal film and patterned in a layer above the gate lines 36G with a gate insulating film 38G therebetween. As illustrated in FIG. 3, the gate lines 36G and the gate insulating film 38G are continuously formed across the second glass substrate 30A and the flexible circuit board 12. The gate lines 36G extend from the second glass substrate 30A to the control circuit board via the flexible circuit board 12 and ends of the gate lines 36G are connected to the control circuit board. The gate insulating film 38G is made of transparent inorganic material (e.g., silicon oxide film) and patterned to cover entire surfaces of the gate lines 36G to insulate the gate lines 36G from the outside and to protect the gate lines 36G on the flexible circuit board 12 from the outside. The thickness T1 of the flexible circuit board 2 with the thickness of the gate lines 36G and the thickness of the gate insulating film 38G added is about 10 μm for ensuring the strength.

Next, the TFTs 32 that are the switching components on the array board 30 will be described. Sections of the gate lines 36G overlapping the TFTs 32 in the Z-axis direction are configured as gate electrodes 32G of the TFTs 32. As illustrated in FIG. 3, the TFTs 32 are disposed in a layer above the gate electrodes 32G. Sections of the source lines overlapping the TFTs 32 in the Z-axis direction are configured as source electrodes 32S of the TFTs 32. The TFTs 32 include drain electrodes 32D opposed to the source electrodes 32S with predetermined gaps therebetween in the Y-axis direction to form an island pattern. The drain electrodes 32D are made of the same material as that of the source lines and formed on the array board 30 by patterning in the same process as the source electrodes.

As illustrated in FIG. 3, in each TFT 32, a semiconductor film 37 is formed on the gate insulating film 38G to connect the source electrode 32S to the drain electrode 32D. The semiconductor film 37 may be an amorphous silicon (a-Si) semiconductor film, a low temperature polysilicon (LIPS) semiconductor film, an oxide semiconductor film, or another kind of semiconductor film. The source electrode 32S and the drain electrode 32D are opposed to each other with the predefined gap therebetween and not directly electrically connected to each other. The source electrode 32S and the drain electrode 32D are electrically connected to each other via the semiconductor film in the layer below them. A bridging section of the semiconductor film 37 between the electrodes 32S and 32D functions as a channel through which a drain current flows. In a layer above the electrodes 32S and 32D and the semiconductor film 37, an interlayer insulating film 39 is formed to cover the electrodes 32S and 32D and the semiconductor film 37. The interlayer insulating film 39 is made of transparent inorganic material and functions as a planarization film for planarizing a surface.

As illustrated in FIG. 3, the interlayer insulating film 39 includes first contact holes CH1 at positions overlapping sections of the drain electrodes 32D in the Z-axis direction. The first contact holes CH1 are through holes that open in the top-bottom direction. The drain electrodes 32D are exposed through the first contact holes CH1. Each pixel electrode 34 is formed in a section above the interlayer insulating film 39 to across the corresponding first contact hole CH1. The pixel electrode 34 is connected to the drain electrode 32D via the first contact hole CH1. When the pixel electrode 34 is connected to the drain electrode 32D, a voltage is applied to the gate electrode 32G of the TFT 32 (the TFT 32 is turned on), a current flows between the source electrode 32S and the drain electrode 32D via the channel and a predefined voltage is applied to the pixel electrode 34.

The source lines and the capacitive lines are connected to the gate lines 36G at the end of the array board 30 connected to the flexible circuit board 12. A reference voltage or signals are input from the control circuit board to the gate lines 36G, the source lines and the capacitive lines via the gate lines 36G patterned on the flexible circuit board 12. With the reference voltage and the signals, the driving of the TFTs 32 is controlled. In this specification, lines formed on the flexible circuit board 12 are referred to as “the gate lines” for the purpose of illustration. However, signals input via the lines formed on the flexible circuit board 12 include not only the gate signals but also source signals and touchscreen signals. Lines made of different materials may be formed on the flexible circuit board with a multi-layer configuration. As described earlier, the gate lines 36G are continuously formed across the array board 30 and the flexible circuit board 12. Therefore, proper electrical connection is established between the control circuit board and the thin film patterns 30L formed on the array board 30 via the gate lines 30G.

Next, a configuration of the color filter board 20 in the display area A1 of the liquid crystal panel 10 will be described. As illustrated in FIG. 2, color filters 22 are disposed on the inner surface of the first glass substrate 20A (on the liquid crystal layer 18 side) of the color filter board 20 at positions overlapping the pixel electrodes 34 of the array board 30 in the plan view. The color filters 22 are arranged in a matrix. The color filters 22 include red (R), green (G), and blue (B) color sections. A light blocking section 23 (a black matrix) for reducing color mixture is formed in a grid among the color sections of the color filters 22. The light blocking section 23 overlaps the gate lines 36G (except for those on the flexible circuit board 12), the source lines, and the capacitive lines on the array board 30 in the plan view.

In the liquid crystal panel 10, a red (R) color section, a green (G) color section, a blue (B) color section, and three pixel electrodes 34 opposed to them form a single display pixel, which is a display unit. The display pixel includes a red pixel including the R color section, a green pixel including the G color section, and a blue pixel including the B color section. Pixels in those colors are repeatedly arranged in the row direction (the X-axis direction) on a plate surface of the liquid crystal panel 10 to form lines of pixels. The lines of pixels are arranged in the column direction (the Y-axis direction). As illustrated in FIG. 2, a counter electrode 24 is formed on inner surfaces of color filters 22 and light blocking sections 23 to be opposed to the pixel electrodes 34 on the array board 30. The counter electrode is connected to a counter electrode line, which is not illustrated, in the non-display area A2 of the liquid crystal panel 10. A reference voltage is applied to the counter electrode 24 via the counter electrode line. By controlling the voltage applied to the pixel electrodes 34 by the TFTs 32, a predefined voltage difference is produced between the pixel electrodes 34 and the counter electrode 24.

In the liquid crystal panel 10 in this embodiment, the first end of the flexible circuit board 12 is disposed in the recess 30A1 of the array board 30 to overlap the section of the sealant 40 in the Z-axis direction. Therefore, it is not necessary to configure the array board 30 to project outward from the sealant 40 for connecting the flexible circuit board 12 to the liquid crystal panel 10. Namely, a mounting area for mounting the flexible circuit board 12 is not required outside the sealant 40. As illustrated in FIGS. 2 and 3, the end surfaces of the glass substrates 20A and 30A of the color filter board 20 and the array board 30 are substantially flush with end surfaces of the sealant 40. According to the configuration, a narrow frame can be provided.

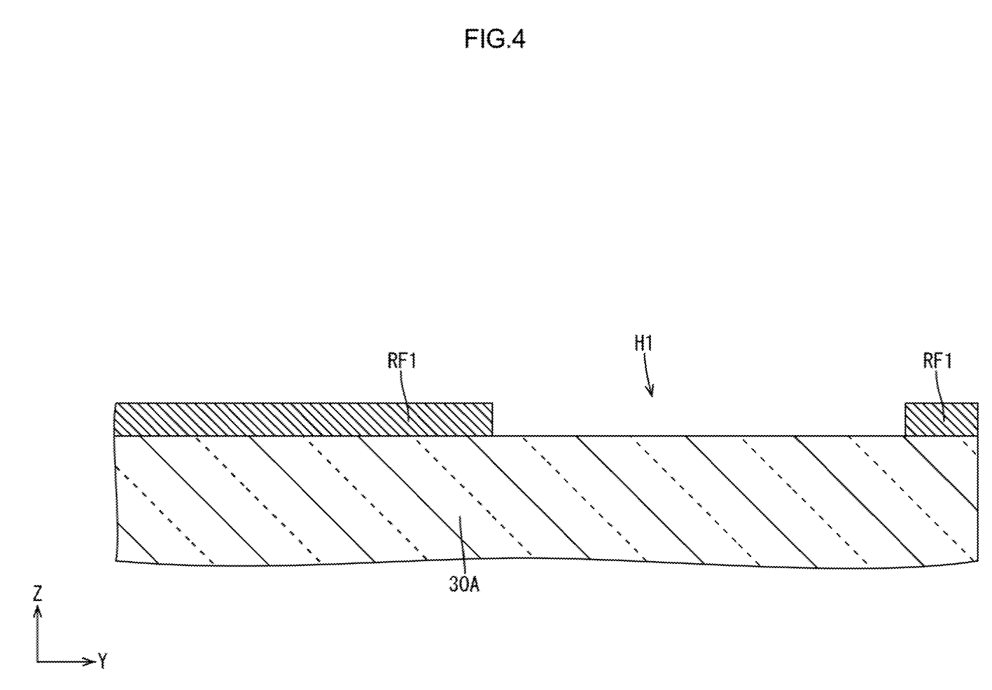

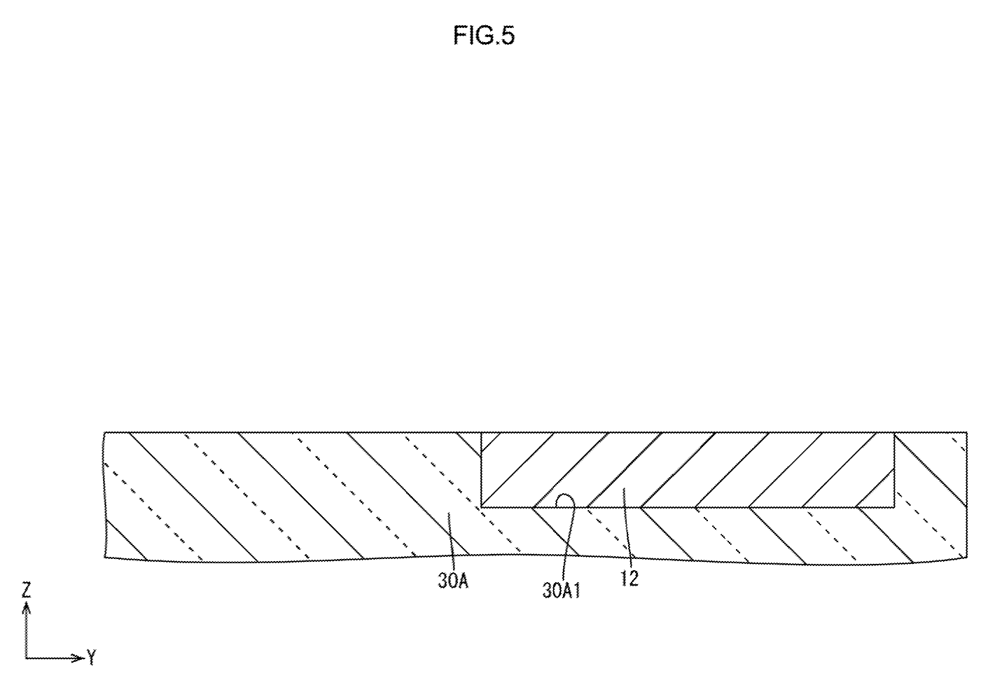

The configuration of the liquid crystal panel 10 according to this embodiment is described above. Next, the method of producing the liquid crystal panel 10 having the configuration described above. In this section, a method of producing the array board 30 will be described especially in detail. First, the method of producing the array board 20 will be described. As illustrated in FIG. 4, in a production process of the array board 30 in this embodiment, a resist film RF1 including a hole H1 formed by patterning is formed on the second glass substrate 30A. Next, a section of the second glass substrate 30A in the hole H1 is wet-etched using an etching solution, for example, a hydrofluoric acid based etching solution and the resist film RF1 as a mask. As a result, the recess 30A1 (see FIG. 5) with a predefined depth (e.g., about 10 μm to 30 μm) is formed in the section of the second glass substrate 30A (a recess forming process).

Next, as illustrated in FIG. 5, the flexible circuit board 12 is formed from a polyimide film in the recess 30A1 formed in the second glass substrate 30A using a known lithography method. Namely, the polyimide film is formed on an entire area of the second glass substrate 30A and patterned to form the flexible circuit board 12 only within the recess 30A1 (a resin film forming process). The thickness of the flexible circuit board 12 is formed inside the recess 30A1 with the thickness adjusted such that the upper surface of the second glass substrate 30A and the upper surface of the flexible circuit board 12 are flush with each other.

In the resin film forming process, the flexible circuit board 12 may be formed by applying the polyimide film only inside the recess 30A1 by screen printing instead of the photolithography method. The flexible circuit board 12 may be formed by attaching the polyimide film to the inside of the recess 30A1. A thin film made of spin on glass (SOG) material may be formed on the flexible circuit board 12 by applying the SOC material to the surface of the flexible circuit board 12. This can increase the flatness of the surface of the flexible circuit board 12.

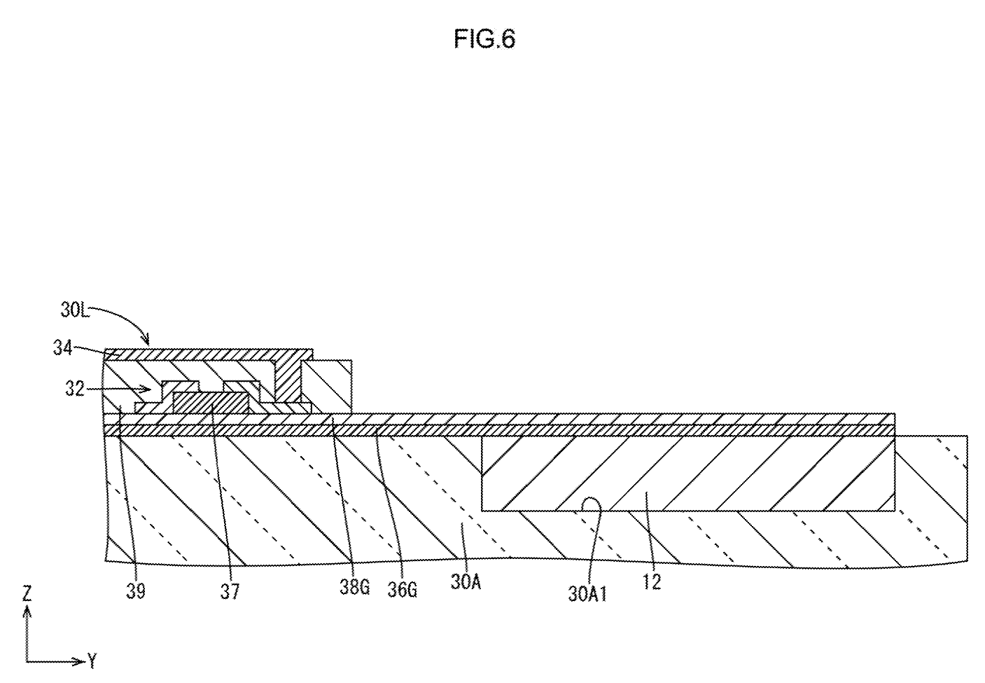

As illustrated in FIG. 6, the gate lines 36G are formed on one of the sections of the second glass substrate 30A separated by the flexible circuit board 12 and on the flexible circuit board 12 through patterning (a metal line forming process). Next, the gate insulating film 38G is formed to cover the gate lines 36G through patterning. As illustrated in FIG. 6, the source lines and the semiconductor film 37 are formed on the second glass substrate 30A (on the gate insulating film 38G) to form the TFTs 32 in other sections of the second glass substrate 30A (in the sections in which the flexible circuit board 12 is not formed). Sections of the source lines formed through patterned and overlapping the TFTs 32 are configured as the source electrodes 32S and the drain electrodes 32D. Sections of the source lines formed through patterned and overlapping the TFTs 32 are configured as gate electrodes 32G.

In the process for forming the TFTs 32 on the array board 30, a post-exposure bake may be performed to increase adhesion between the films of the TFTs 32. In the post-exposure bake, the second glass substrate 30A is subjected to heat treatment at high temperature (e.g., about 400° C.). The decomposition temperature of the polyimide, which is a material of the flexible circuit board 12, is 500° C. or higher, that is, the polyimide has higher heat resistance in comparison to regular polymers. Therefore, even if the post-exposure bake is performed in the formation of the TFTs 32 after the formation of the flexible circuit board 12 as in this embodiment, the material of the flexible circuit board 12 is less likely to be decomposed by heat, that is, an adverse effect is less likely to be exerted on the flexible circuit board 12.

As illustrated in FIG. 6, the interlayer insulating film 39 is formed through patterning to cover the TFTs 32 and planarize the surfaces of the TFTs 32. The pixel electrodes 34 are formed on the surface of the interlayer insulating film 39 through patterning. Through the steps described above, the thin film patterns 30L including multiple thin film patterns in layers on the second glass substrate 30A of the array board 30 are formed (a pattern forming process). The alignment film 10B is formed on the surfaces of the interlayer insulating film 39 and the pixel electrodes 34. Through the above steps, the array board 30 is complete.

A method of producing the color filter board 20 will be briefly described. In a production process of the color filter board 20, the light blocking section 23 that is a thin film is formed on the first glass substrate 20A and processed into a grid by the photolithography method. The light blocking section 23 is made of titanium, for example. The color sections of the color filters 22 are formed at predefined positions. The counter electrode 24 is formed to cover the light blocking section 23 and the color filters 22. A transparent insulating film (not illustrated), which is a protective film, is formed to cover the counter electrode. The insulating film is made of silicon dioxide, for example. The alignment film 10A is formed on the surface of the insulating film. Through the above steps, the color filter board 20 is complete.

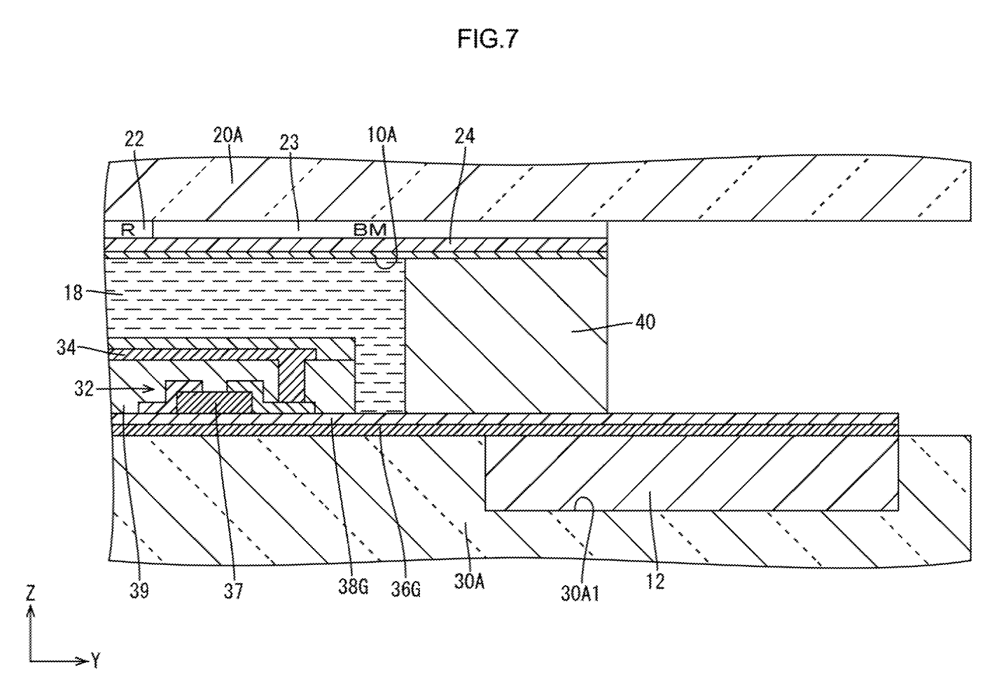

When the array board 30 and the color filter board 20 are complete, the sealant 40 is applied onto the second glass substrate 30A in a form of a rectangle along the outline of the second glass substrate 30A. As illustrated in FIG. 7, the sealant 40 is applied onto the second glass substrate 30A and the flexible circuit board 12 while adjusting application positions such that a section of the sealant 40 overlaps the first end of the flexible circuit board 12 in the Z-axis direction and the width of the overlapping section of the flexible circuit board 12 is equal to the width W1 described earlier. The first glass substrate 20A of the color filter board 20 is set opposite the second glass substrate 30A and positioned such that the end surface of the first glass substrate 20A is aligned with the end surface of the second glass substrate 30A (see FIG. 7). The liquid crystals are injected into a section of the second glass substrate 30A surrounded by the sealant 40 by the one drop fill (ODF) method using a liquid crystal dropping device to form the liquid crystal layer 18. As illustrated in FIG. 7, the first glass substrate 20A is held opposite the second glass substrate 30A and bonded to the second glass substrate 30A with the sealant 40 (a bonding process).

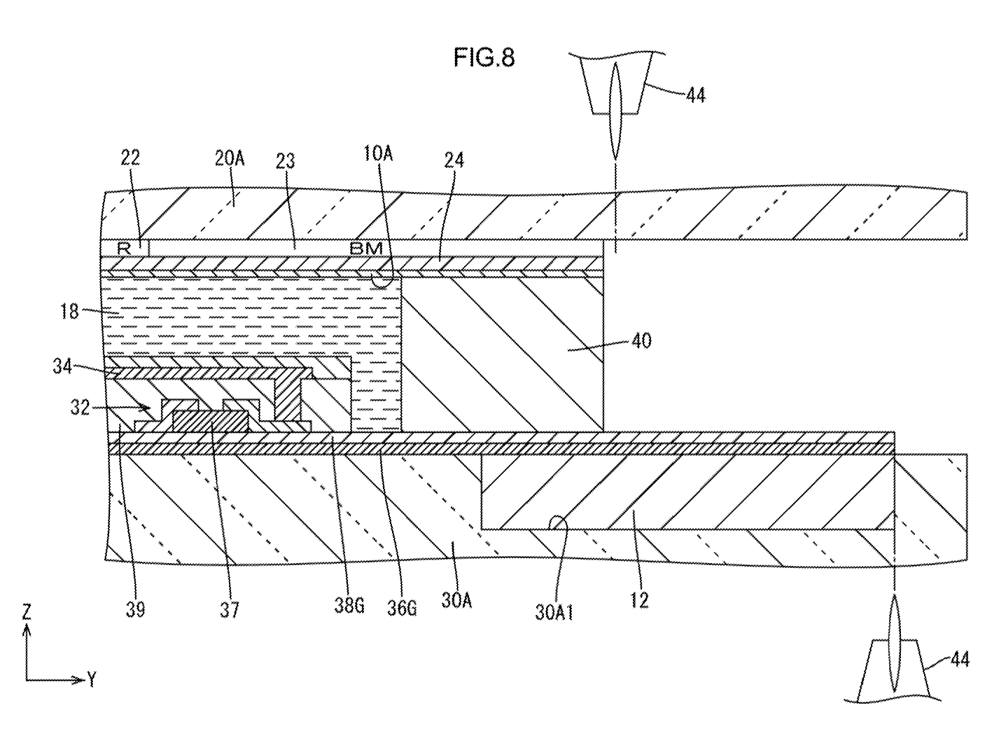

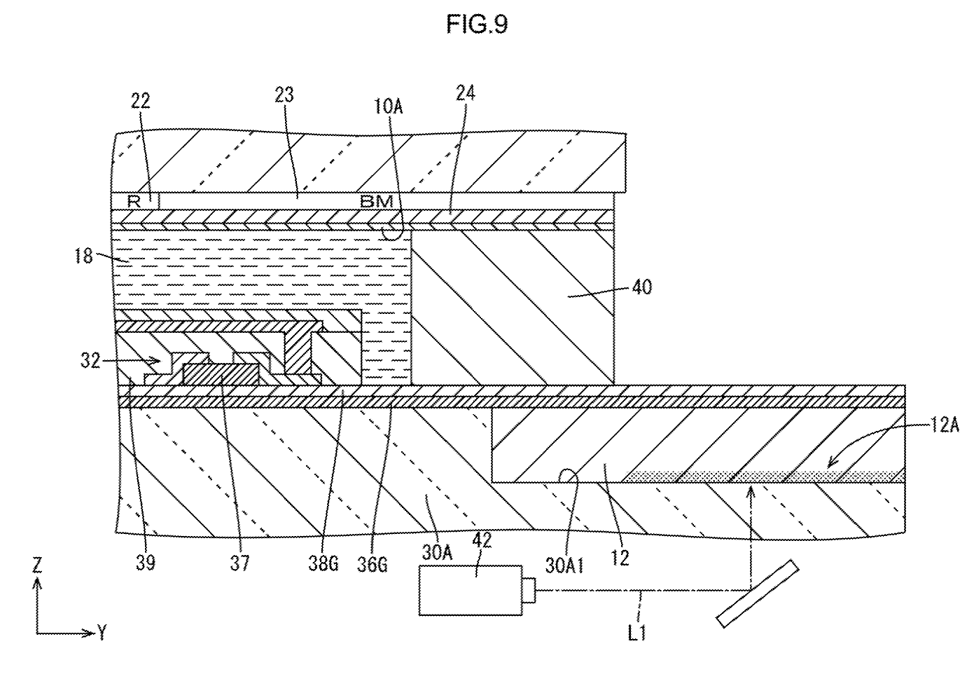

As illustrated in FIG. 8, the first glass substrate 20A is cut at a boundary between a section outside the sealant 40 and other section using a scriber 44 to remove the section of the first glass substrate 20A outside the sealant 40 (a second substrate removing process). The second glass substrate 30A is cut at an end of the flexible circuit board 12 in the Y-axis direction, that is, a boundary between the flexible circuit board 12 and the second glass substrate 30A outside the sealant 40 using the scriber 44 to remove the section of the second glass substrate 30A outside the boundary (a first substrate removing process). As illustrated in FIG. 9, an outer end surface of the flexible circuit board 12 is exposed to the outside of the recess 30A1.

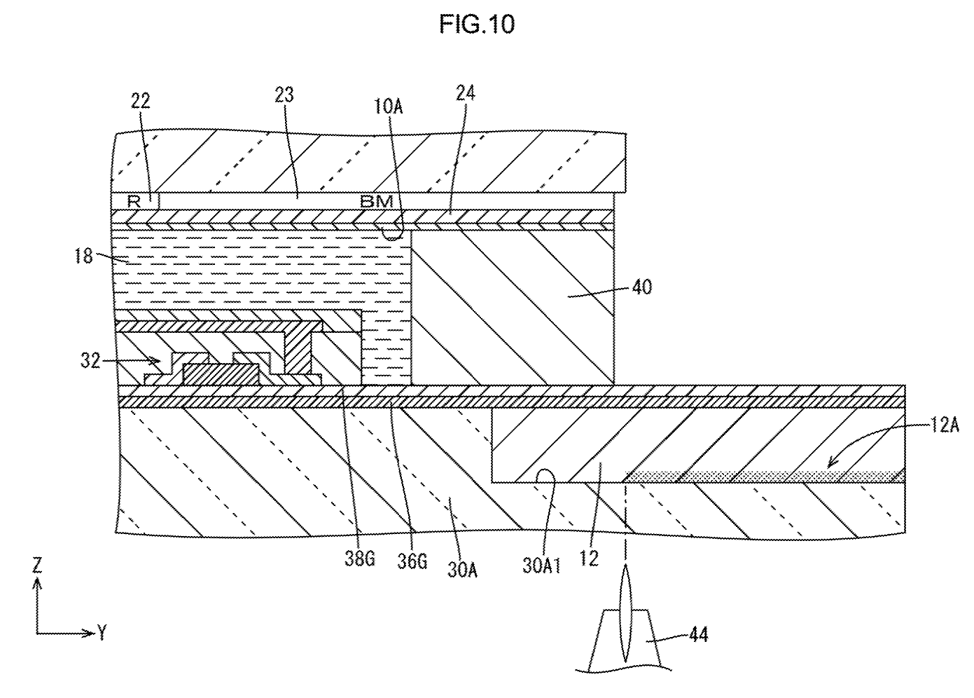

As illustrated in FIG. 9, a laser beam L1 is applied to a section of the boundary between the recess 30A1 formed in the second glass substrate 30A and the flexible circuit board 12 outside the sealant 40 by a laser beam applying unit 42 (a laser beam applying process). As a result, a weak layer 12A is formed in a section of the flexible circuit board 12 to which the laser beam L1 is applied. As illustrated in FIG. 10, the second glass substrate 30A is cut at a boundary between the section outside the sealant 40 and other section to separate a section of the second glass substrate 30A under the recess 30A1 outside the sealant 40 and remove the section (a first substrate removing process). Because the weak layer 12A is formed in the section of the flexible circuit board 12, the section of the second glass substrate 30A under the recess 30A1 can be easily removed from the flexible circuit board 12.

A section of the flexible circuit board 12 outside the recess 30A1 and outside the sealant 40 is folded at about right angle to the plate surface of the second glass substrate 30A toward the back side (an opposite side from the first glass substrate 20A) (a folding process). The polarizing plates 10C and 10D are bonded to the outer surfaces of the glass substrates 20A and 30A and the second end of the flexible circuit board 12 (an end folded toward the back side in the folding process) is connected to the control circuit board. The ends of the gate lines 36G are projected from the gate insulating film 38G and connected to the control circuit board. The IC chip is mounted on the control circuit board. This completes the liquid crystal panel 10. The backlight unit is fixed to the back of the liquid crystal panel 10. This completes the liquid crystal display device 1 according to this embodiment.

As described above, in the method of producing the liquid crystal panel 10 in this embodiment, the thin film patterns 30L including multiple thin film patterns are formed in the other section of the second glass substrate 30A in the pattern forming process. The sections of the gate lines 36G formed in the other section of the second glass substrate 30A are configured as the gate electrodes 32G of the TFTs 32. In the metal line forming process, the gate lines 36G are formed to continue from the other section of the second glass substrate 30A to the flexible circuit board 12. The polyimide film formed in the section of the second glass substrate 30A in the resin film forming process is configured as the flexible circuit board 12 for transmitting the signals for driving the produced liquid crystal display device 1. According to the method, the flexible circuit board 12 is connected onto the second glass substrate 30A without press-bonding the first end of the flexible circuit board 12 onto the second glass substrate 30A.

The bonding process is performed after the other processes. As described above, the sealant 40 can be applied such that the first end of the flexible circuit board 12 inside the recess 30A1, that is, the connecting section of the flexible circuit board 12 and the second glass substrate 30A is located at a position overlapping the sealant 40 in the Z-axis direction. In the second substrate removing process and the first substrate removing process, about entire sections of the first glass substrate 20A and the second glass substrate 30A outside the sealant 40 can be removed without maintaining mounting areas for mounting the flexible circuit board outside the sealant as in the known technology. In comparison to the known liquid crystal display device including the mounting area for mounting the flexible circuit board outside the sealant, the frame width of the liquid crystal display device 1 can be reduced.

The thickness of the flexible circuit board 12 is about 10 μm. If the flexible circuit board is formed without forming the recess in the second glass substrate, a difference in level may be created between the upper surface of the second glass substrate and the upper surface of the flexible circuit board. If the difference is created, adjustment of the distance between the second glass substrate and the first glass substrate (the cell gap) may become difficult in the bonding process. This may create a difference between a forming condition of the gate lines and the gate insulating film on the upper surface of the second glass substrate and forming a condition of the gate lines and the gate insulating film on the upper surface of the flexible circuit board in the metal line forming process. The forming of the gate lines and the gate insulating film may become difficult. Yield in the production process of the liquid crystal display device may decrease.

In this embodiment, the recess 30A1 is formed in the second glass substrate 30A and the flexible circuit board 12 is formed inside the recess 30A1. Therefore, a difference in level is less likely to be created between the upper surface of the second glass substrate 30A and the upper surface of the flexible circuit board 12. Therefore, the above-described problems are less likely to occur and thus the decrease in yield in the production process of the liquid crystal display device 1 is less likely to occur.

In the resin film forming process in this embodiment, the flexible circuit board 12 is formed in the recess 30A1 such that the upper surface of the second glass substrate 30A is flush with the upper surface of the flexible circuit board 12. Therefore, the creation of difference in level between the upper surface of the second glass substrate 30A and the upper surface of the flexible circuit board 12 is effectively reduced.

The polyimide film of the flexible circuit board 12 is opaque. If a section of the flexible circuit board 12 overlaps the display area Al of the liquid crystal panel 10, a display failure may occur in the overlapping area. In the liquid crystal display device 1 produced by the method in this embodiment, the first end of the flexible circuit board 12 overlaps only the non-display area A2 of the liquid crystal panel 10 in the Z-axis direction. Therefore, such a display failure or degradation in display quality is less likely to occur.

### Second Embodiment

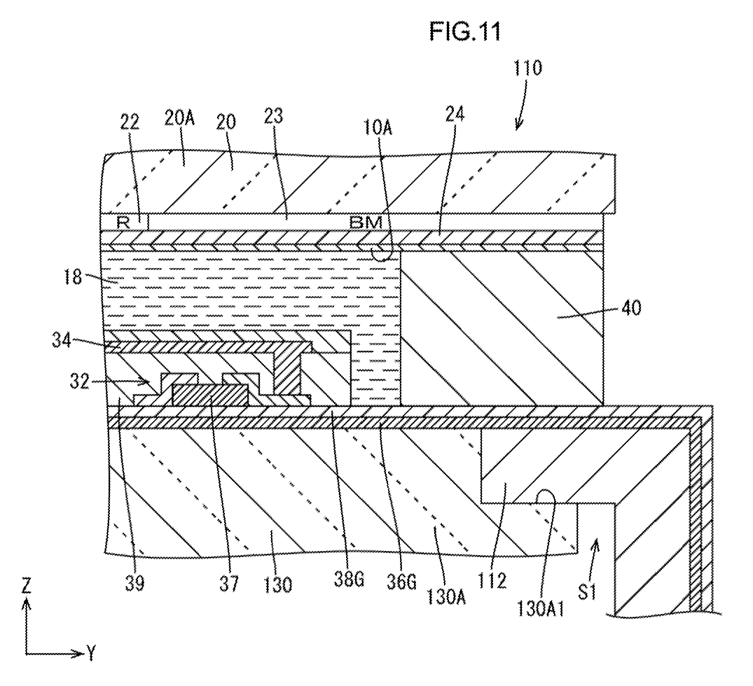

A second embodiment of the present invention will be described with reference to FIG. 11. A liquid crystal display device according to this embodiment includes a flexible circuit board 112 folded differently from the first embodiment. Other configurations are similar to those of the first embodiment and thus will not be described. As illustrated in FIG. 11, a liquid crystal panel 110 in this embodiment includes a gap S1 between a folded section of the flexible circuit board 112 and the second glass substrate 30A. Therefore, the end surface of the second glass substrate 30A and the folded section of the flexible circuit board 112 do not contact each other.

In a folding process of the production process of the liquid crystal panel 110 having such a configuration, a section of the flexible circuit board 112 is folded such that the gap S1 is provided between the end surface of the second glass substrate 30A and the folded section of the flexible circuit board 112. In the liquid crystal panel 110 in this embodiment, the end surface of the second glass substrate 30A and the folded section of the flexible circuit board 112 do not contact each other because of the gap S1. Therefore, the folded section of the flexible circuit board 112 is less likely to be damaged by the end surface of the second glass substrate 30A.

### Modification of the Second Embodiment

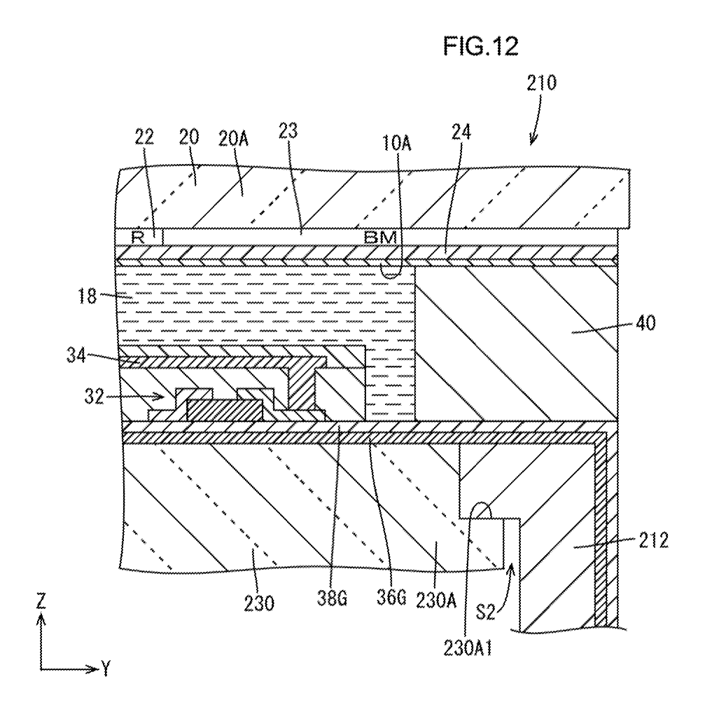

A modification of the second embodiment will be described with reference to FIG. 12. A liquid crystal display device according to this modification includes a second glass substrate 230A cut differently from the second embodiment and a flexible circuit board 212 folded differently from the second embodiment. Other configurations are similar to those of the liquid crystal display device described in the second embodiment section. As illustrated in FIG. 12, a liquid crystal panel 210 includes a gap S2 between a folded section of the flexible circuit board 212 and the second glass substrate 230A. Furthermore, the folded section overlaps the sealant 40 in the Z-axis direction. The liquid crystal panel 210 has a configuration in which the folded section of the flexible circuit board 212 does not project outward from the sealant 40.

The liquid crystal panel 210 having such a configuration is produced as follows. In a second first substrate removing process, the second glass substrate 230A is cut at the section overlapping the sealant 40 to separate a section of the second glass substrate 230A under a recess 230A from the flexible circuit board 212 and remove the section. In a folding process, a section of the flexible circuit board 212 is folded such that the gap S1 is provided between an end surface of the second glass substrate 230A and the folded section of the flexible circuit board 212 and the folded section overlaps the sealant 40 in the Z-axis direction. In this modification, the folded section of the flexible circuit board 212 is maintained inside the sealant 40 after the folding process. Therefore, the liquid crystal display device including a frame in further reduced size is produced.

### Third Embodiment

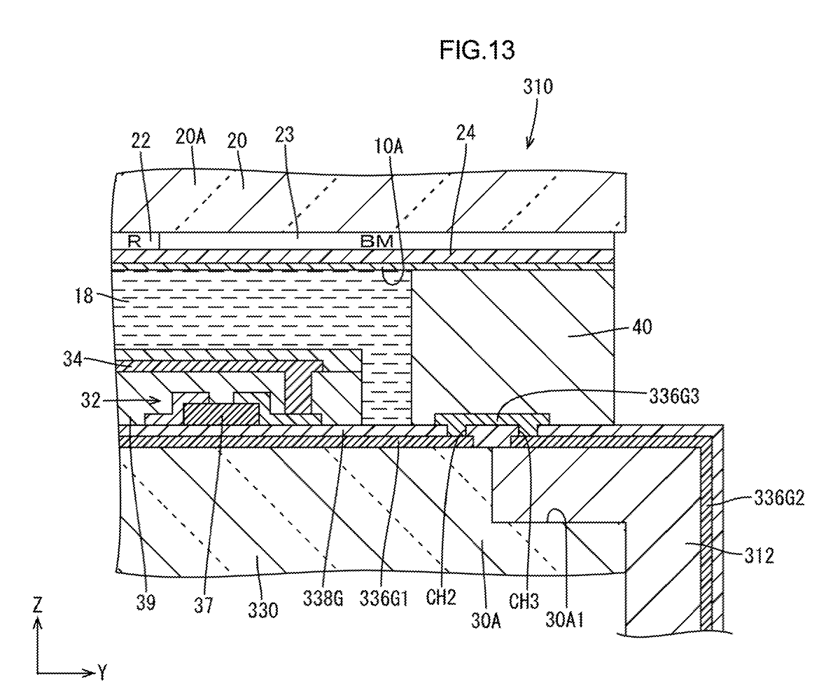

A third embodiment will be described with reference to FIG. 13. A liquid crystal display device according to this embodiment includes gate lines 336G1 and 336G2 that are continuously formed on a second glass substrate 330A and a flexible circuit board 312, which are different from the first embodiment. Other configurations are similar to those of the first embodiment and thus will not be described. In this embodiment, as illustrated in FIG. 13, the gate lines 336G1 and the 336G2 in a liquid crystal panel 310 include the first gate lines 336G1 formed on the second glass substrate 30A of an array board 330 and second gate lines 336G2 formed on the flexible circuit board 312. No metal lines are formed at a boundary between the second glass substrate 30A and the flexible circuit board 312.

In this embodiment, as illustrated in FIG. 13, a gate insulating film 338G includes a second contact hole CH2 and a third contact hole CH3 at positions overlapping the sealant 40. The second contact hole CH2 and the third contact hole CH3 are through holes that open in the top-bottom direction. First ends of the first gate lines 336G1 inside the second contact hole CH2 are exposed. First ends of the second gate lines 336G2 inside the third contact hole CH3 are exposed. Third gate lines 336G3 are formed in a section of the gate insulating film 338G overlapping the sealant 40 to cross the second contact hole CH2 and the third contact hole CH3.

First ends of the third gate lines 336G3 are electrically connected to the first gage lines 336G1 via the second contact hole CH2 and second ends of the third gate lines 336G3 are electrically connected to the second gate lines 336G2. Therefore, the first gate lines 336G1 and the second gate lines 336G2 are electrically connected to each other via the third gate lines 336G3. The gate lines 336G1, 336G2, and 336G3 are metal lines formed from metal films. They may be made of the same metal material or different metal materials. Signals input from the second gate lines 336G2 formed on the flexible circuit board 312 include gate signals and touchscreen signals. Therefore, the second gate lines 336G2 may have a multi-layer configuration including lines made of different materials.

The liquid crystal panel 310 having such a configuration in this embodiment is produced as follows. In a metal line forming process, the first gate lines 336G1 are formed on the second glass substrate 30A and the second gate lines 336G2 are formed on the flexible circuit board 312. At this moment, the gate lines 336G1 and 336G2 are not electrically connected to each other. The gate insulating film 338G is formed on the gate lines 336G1 and 336G2. The second contact hole CH2 is formed in a section of the gate insulating film 338G overlapping the sealant 40 such that the first ends of the first gate lines 336G1 are disposed inside the second contact hole CH2 and exposed. The third contact hole CH3 is formed and the first ends of the second gate lines 336G are disposed inside the third contact hole CH3 and exposed.

The third gate lines 336G3 are formed in a section of the gate insulating film 338G overlapping the sealant 40 to cross the second contact hole CH2 and the third contact hole CH3. As a result, the gate lines 336G1 and 336G2 are electrically connected to each other. Similar to the first embodiment, the pattern forming process, the bonding process, the laser beam applying process, the second substrate removing process, and the first substrate removing process are performed. Through the processes, the liquid crystal panel 310 in this embodiment is complete.

In each of the above embodiments, the end of the flexible circuit board formed inside the recess may have a concave shape or a projecting shape after the resin film forming process. This may create a small difference in level between the second glass substrate and the flexible circuit board at the boundary between the second glass substrate and the flexible circuit board. If the metal lines are formed across the boundary between second glass substrate and the flexible circuit board and such a difference is created, the metal lines may break at the boundary. In this embodiment, the metal lines are not formed across the boundary but the metal lines (the first gate lines 336G1, the second gate lines 336G2, and the third gate lines 336G3) continue from the second glass substrate 30A to the flexible circuit board 312. Therefore, the break of the metal lines due to the difference in level is less likely to occur.

### Modification of the Third Embodiment

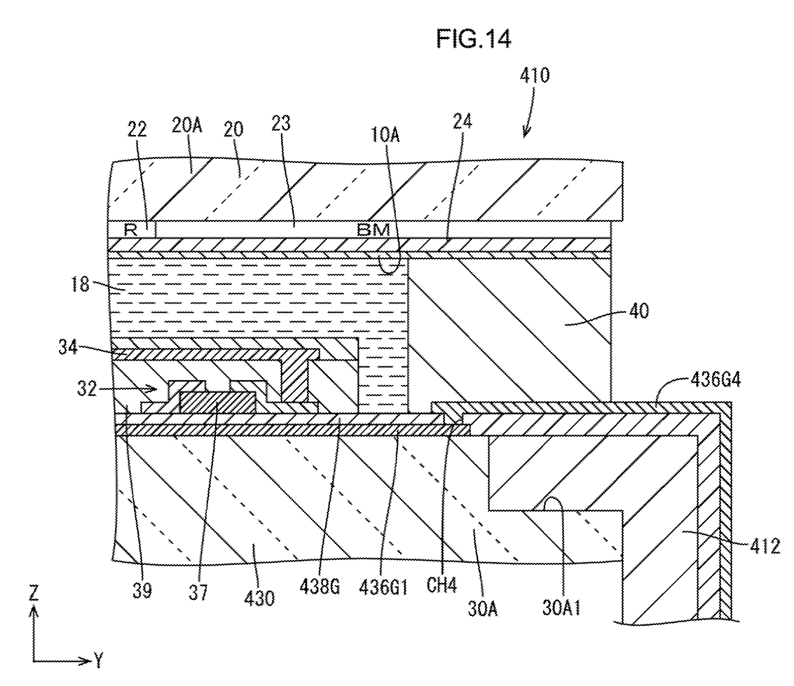

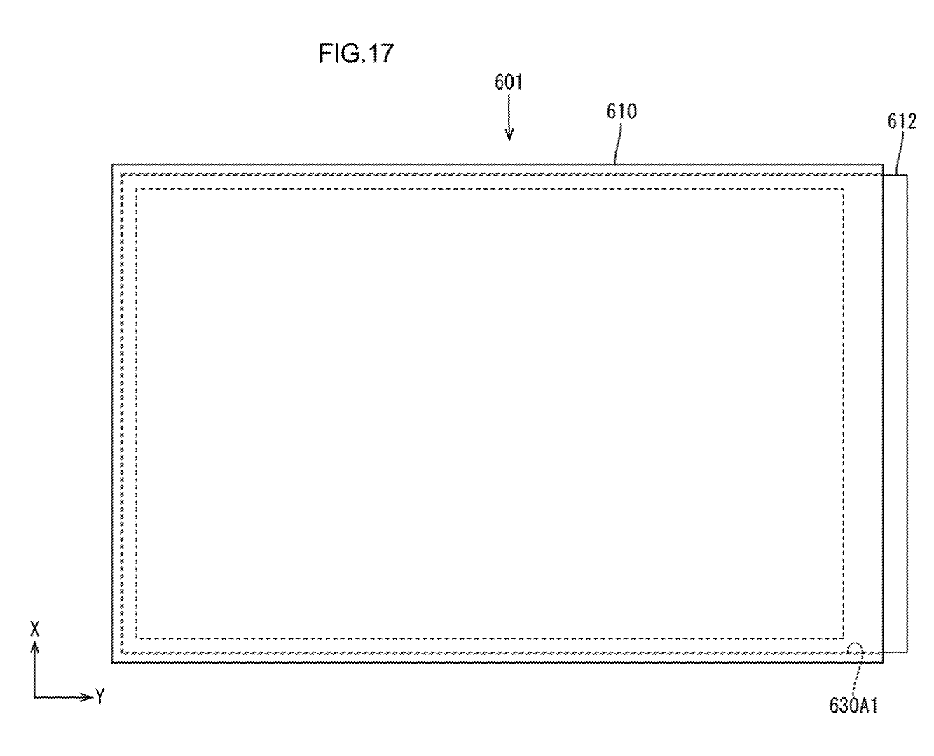

A modification of the third embodiment will be described with reference to FIG. 17. A liquid crystal display device according to this modification includes gate lines 436G1 and 436G4 that are continuously formed on the second glass substrate 30A and a flexible circuit board 412, which are different from the third embodiment. Other configurations are similar to the liquid crystal display device 401 of the third embodiment. In this modification, as illustrated in FIG. 14, the gate lines 436G1 and the 436G2 of a liquid crystal panel 410 include the first gate lines 436G1 formed on the second glass substrate 30A of the array board 230 and fourth gate lines 436G2 formed on the gate insulation film 438G. No metal lines are formed at a boundary between the second glass substrate 30A and the flexible circuit board 412.

Specifically, according to this embodiment, as illustrated in FIG. 14, the gate insulation film 438 is continuously formed on the first gate lines 436G1 and the flexible circuit board 412. A fourth contact hole CH4 is formed vertically through a portion of the gate insulation film 438G overlapping the sealant 40 and one end portion of the first gate lines 436G1 is exposed from the fourth contact hole CH4. Further, the fourth gate lines 436G4 are formed on a portion of the gate insulation film 438G overlapping the sealant 40 and a portion thereof overlapping the flexible circuit board 412 and the fourth gate lines 436G4 covers the fourth contact hole CH4. One ends of the fourth gate lines 436G4 are electrically connected to the respective first gate lines 436G1 via the fourth contact hole CH4 and the first gate lines 436G1 and the fourth gate lines 436G4 are electrically connected to each other. The gate lines 436G1, 436G4 are metal lines made of a metal film and may be made of same metal material or may be made of different metal material.

The liquid crystal panel 410 having such a configuration in this embodiment is produced as follows. In a metal line forming process, the first gate lines 436G1 are formed on the second glass substrate 30A and the gate insulation film 438G is continuously formed on the first gate lines 436G1 and the flexible circuit board 412 to cover the first gate lines 436G1. Next, the fourth contact hole CH4 is formed in the portion of the gate insulation film 438G overlapping the sealant 40 such that one end portion of the first gate lines 436G1 is exposed from the fourth contact hole CH4. Then, the fourth gate lines 436G4 are formed on a portion of the gate insulation film 438G overlapping the sealant 40 and a portion thereof overlapping the flexible circuit board 412 and the fourth gate lines 436G4 covers the fourth contact hole CH4. As a result, the gate lines 436G1 and 436G4 are electrically connected to each other.

Then, similar to the first embodiment, the pattern forming process, the bonding process, the laser beam applying process, the second substrate removing process, and the first substrate removing process are performed. Through the processes, the liquid crystal panel 310 in this embodiment is complete. As described before, in this embodiment, similar to the third embodiment, the metal lines (the first gate lines 436G1, the fourth gate lines 436G4) are formed continuously on the second glass substrate 30A and the flexible circuit board 412 while no metal lines are formed at the boundary between the second glass substrate 30A and the flexible circuit board 412. Therefore, disconnection of the metal lines is less likely to be caused due to a difference in levels that may be crated between the second glass substrate 30A and the flexible circuit board 412.

### Fourth Embodiment

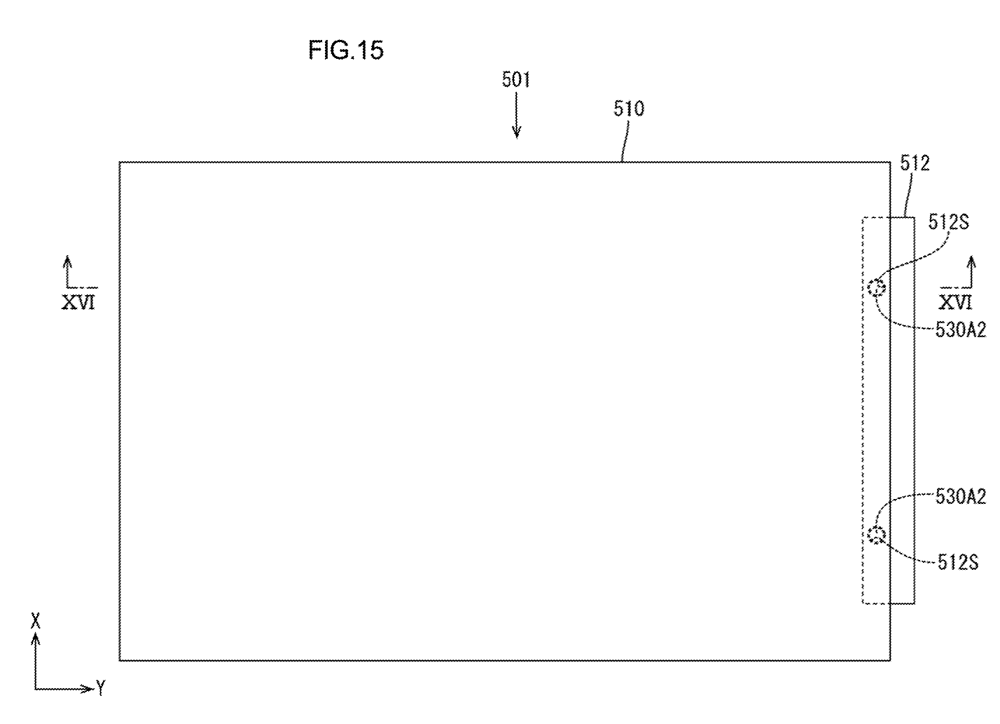

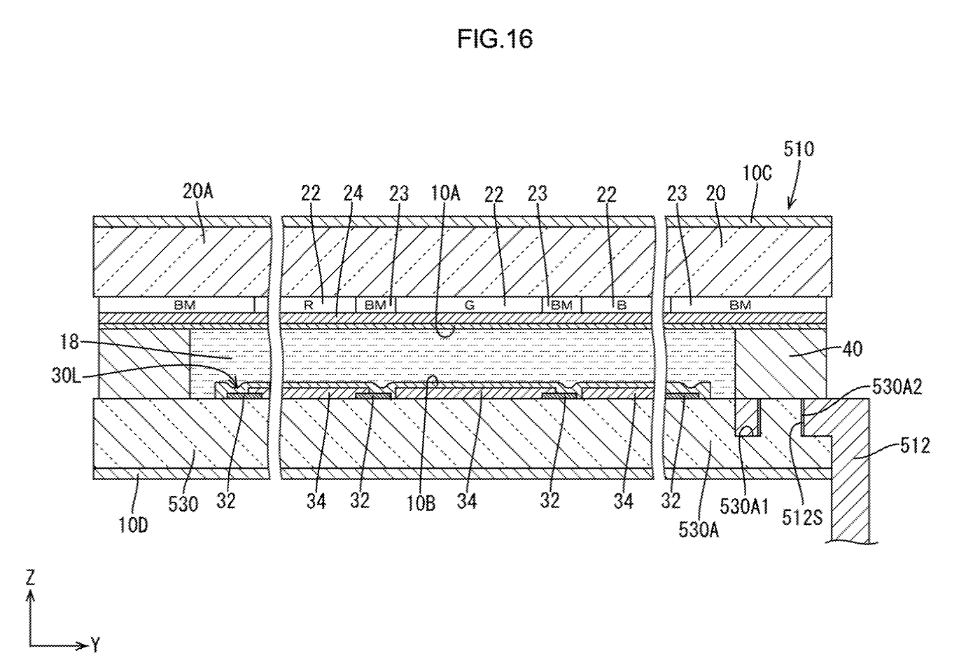

A fourth embodiment of the present invention will be described with reference to FIGS. 15 and 16. A liquid crystal display device 501 according to this embodiment includes a recess 530A1 formed in a second glass substrate 530A and a flexible circuit board 512, which are different from the first embodiment. Other configurations are similar to the first embodiment and thus will not be described. In this embodiment, as illustrated in FIGS. 15 and 16, two projection portions 530A2 are formed in the recess 530A1 that is formed in a section of the second glass substrate 530A. Each of the projection portions 530A2 has a columnar shape and projects in the Z-axis direction (a thickness direction of the second glass substrate 530A). The flexible circuit board 512 has through holes 512S in portions overlapping the projection portions 530A2 with respect to the Z-axis direction (the thickness direction of the second glass substrate 530A). Each of the through holes has an opening diameter that is slightly greater than an outer diameter of each projection portion 530A2.

In this embodiment, each of the projection portions 530A2 formed in the recess 530A1 is inserted through each of the through holes 512S formed in the flexible circuit board 512 and accordingly, the flexible circuit board 512 is stopped by the projection portions 530A2. Therefore, the flexible circuit board 512 is less likely to be detached from the recess 530A1 in a direction crossing a direction in which the projection portions 530A2 are projected, or in an X-Y plane surface direction. Thus, holding strength of the second glass substrate 530A with the flexible circuit board 512 can be increased.

### Modification of the Fourth Embodiment

A modification of the fourth embodiment will be described with reference to FIG. 17. A liquid crystal display device 601 according to this modification includes a recess 630A1 and a flexible circuit board 612. A shape of the recess 630A1 and a shape of a section of the flexible circuit board 612 disposed in the recess 630A1 are different from the first embodiment. Other configurations are similar to those of the liquid crystal display device 1 of the first embodiment. In this modification, as illustrated in FIG. 17, the recess 630A1 is formed along an entire periphery of the second glass substrate. A portion of the flexible circuit board 612 overlapping the recess 630A1 with respect to the Z-axis direction has a frame shape along a peripheral portion of the second glass substrate and is disposed in the recess 630A1.

In this modification, the recess 630A1 is formed in the above shape in a recess forming process and the flexible circuit board 612 is formed in the above shape and fit in the recess 630A1 in the resin film forming process. Accordingly, the frame-shaped portion of the flexible circuit board is held by the recess 630A1. Therefore, the flexible circuit board 612 is less likely to be removed from the recess 630A1 in the direction crossing the depth direction of the recess 630A1, that is, the X-Y plane surface direction. Thus, the holding strength of the second glass substrate with the flexible circuit board 612 can be increased.

### Fifth Embodiment

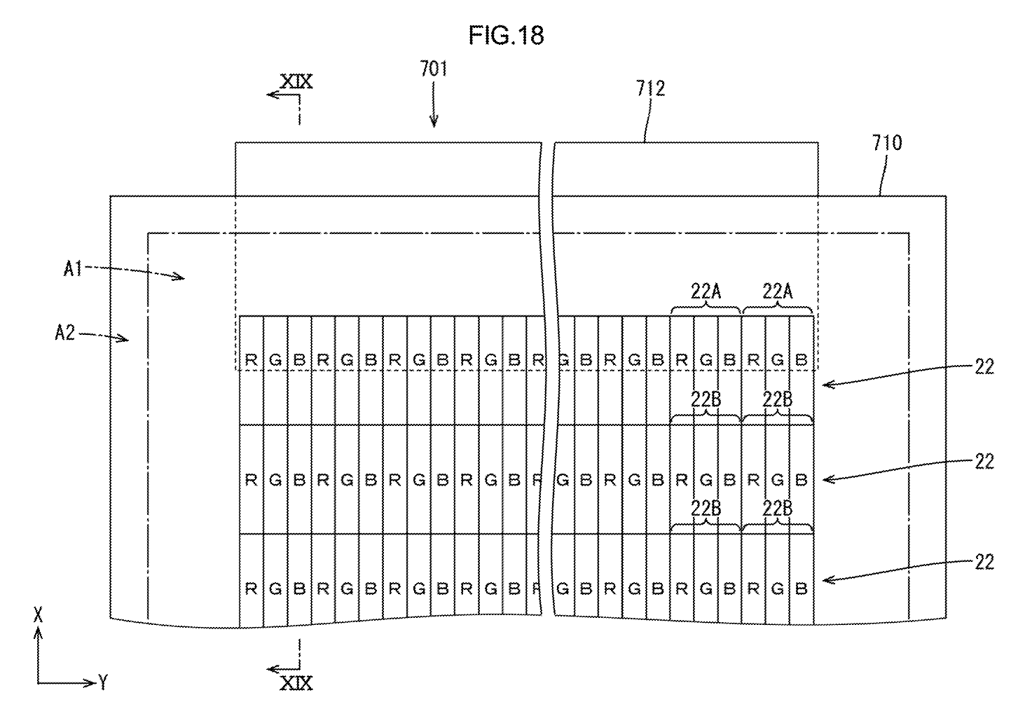

A fifth embodiment of the present invention will be described with reference to FIGS. 18 to 20. In a liquid crystal display device 701 according to this embodiment, a connection between a second glass substrate 730A and a flexible circuit board 712 and a driving method of driving a liquid crystal panel 710 differ from those of the first embodiment. Other configurations are similar to those of the first embodiment and thus will not be described.

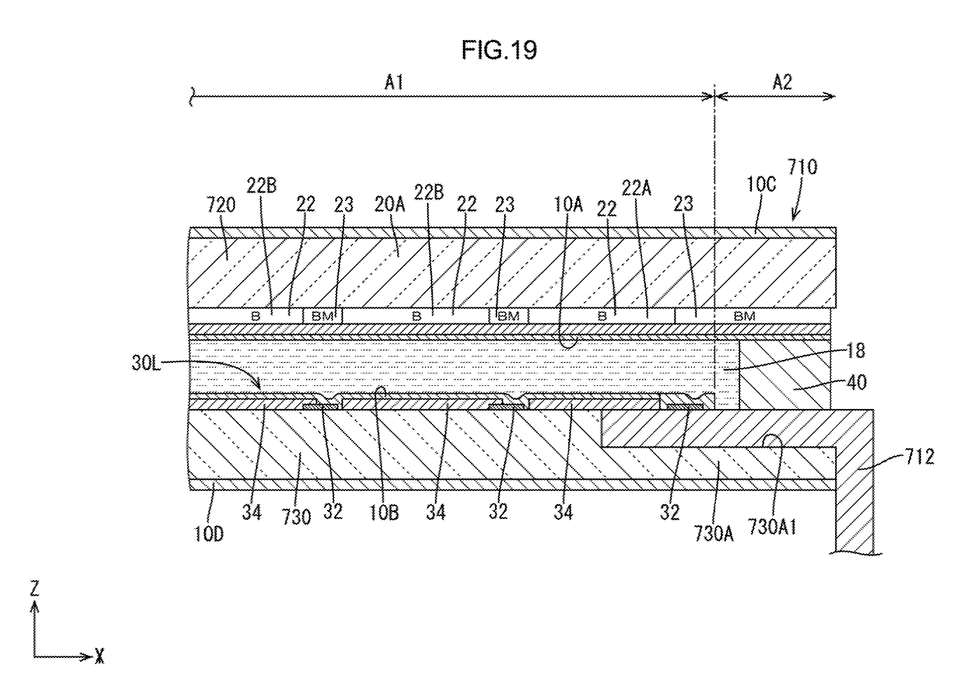

In this embodiment, as illustrated in FIGS. 18 and 19, the second glass substrate 730A includes a recess 730A1 that extends to a portion overlapping the display area A1 with respect to the Z-axis direction. The flexible circuit board 712 has a section that is fit in the recess 730A1 and the section overlaps the non-display area A2 with respect to the Z-axis direction and extends to a portion overlapping the display area A1. Specifically, as illustrated in FIGS. 18 and 19, a most inner-side portion of the section of the flexible circuit board 712 that is fit in the recess 730A1 overlaps a most outer edge-side display pixel 22A (see FIG. 18) of the display pixels 22A, 22B within the display area A1 with respect to the Z-axis direction.

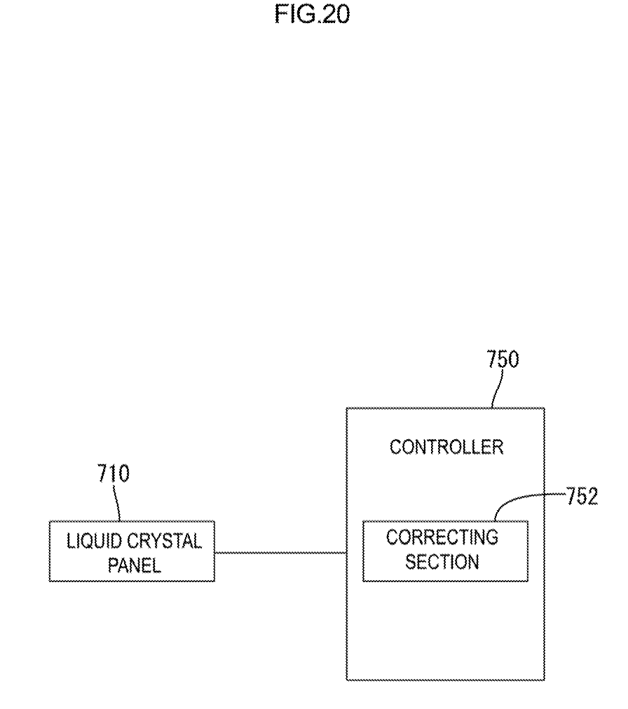

As illustrated in FIG. 20, the liquid crystal display device 701 of this embodiment includes a controller 750 that controls brightness of images displayed on the display area A1 of the display panel 710. The controller 750 includes a correcting section 752 configured to correct the images such that the display pixels 22A on the outermost side within the display area A1 are displayed brighter than other display pixels 22A. In the liquid crystal display device 701 of this embodiment, when images are displayed on the display area A1, the images are corrected by the correcting section 752 of the controller 750 such that the display pixels 22A disposed on the outermost side within the display area A1 are displayed brighter than other display pixels 22B.

If the flexible circuit board is made of opaque material and a part of the flexible circuit board overlaps the display area of the display panel, a display failure may be caused in an image displayed on an overlapping area of the display panel. However, even if brightness is different between the display pixels 22A disposed on the outermost side within the display area A1 and other display pixels 22B, such brightness difference is less likely to be recognized. According to the configuration of this embodiment, even if the flexible circuit board 712 is made of opaque material, the correcting section 752 controls the display pixels 22A disposed on the outermost side to be displayed brighter than the other display pixels 22B. Therefore, brightness difference between the display pixels 22A disposed on the outermost side and other display pixels 22B is less likely to be recognized.

The most inner-side portion of the section of the flexible circuit board 712 that is fit in the recess 730A1 overlaps the most outer edge-side display pixels 22A within the display area A1. Such a configuration can be achieved no matter what the material of the flexible circuit board 712 is, and with the above configuration, brightness difference is less likely to be produced between the display pixels 22A disposed on the outermost side and other display pixels 22B, that is, display failures are less likely to be caused in the displayed images. As a result, most part of the flexible circuit board 712 can be disposed in the recess and the holding strength of the array board 730 with the flexible circuit board 712 can be increased. If the sealant 40 has a reduced width, the section of the flexible circuit board 712 that is disposed in the recess has a sufficient width such that a frame of the liquid crystal display device 701 can be narrower.

If the material of the flexible circuit board 712 has a color that is hard to be corrected such as yellow, a light blocking layer such as a metal film is preferably disposed on a rear-side portion of the flexible circuit board 712 overlapping the display pixels 22A on the outermost side with respect to the Z-axis direction. With such a light blocking layer, the display pixels 22A on the outermost side are blocked from light and cannot function as the pixel. Therefore, brightness difference is further less likely to be caused between the display pixels 22A on the outermost side within the display area A1 and the other display pixels 22B.

Modifications of each of the above embodiments will be described below.

(1) In each of the above embodiments, the upper surface of the second glass substrate is flush with the upper surface of the portion of the flexible circuit board that is fit in the recess. However, the upper surface of the second glass substrate may not be flush with the upper surface of the portion of the flexible circuit board. Without the above a configuration, by disposing a section of the flexible circuit board in the recess, difference in level between the second glass substrate and the flexible circuit board can be smaller compared to a configuration that a part of the flexible circuit board is formed on the second glass substrate. A distance between the glass substrate and the first substrate can be effectively controlled in the bonding process and the metal lines are optimally formed in the metal line forming process.

(2) In each of the above embodiments, the flexible circuit board is made of a polyimide film that is opaque. However, the material of the flexible circuit board is not limited thereto but may be made of transparent material having transmissivity. With such a configuration, display failures or deterioration of display quality are less likely to occur even if a part of the flexible circuit board overlaps the display area.

(3) In each of the above embodiments, the liquid crystal panel has a rectangular plan view shape. However, a liquid crystal panel having an outline a part of which is curved may be included in a scope of the present invention.

(4) In each of the above embodiments, the liquid crystals are injected into a section surrounded by the sealant by the one drop fill (ODF) method using the liquid crystal dropping device to form the liquid crystal layer between the substrates. However, it is not limited thereto and the liquid crystals may be injected into a section between the substrates after the bonding process.

(5) In each of the above embodiments, a driving type of the liquid crystal panel is a twisted nematic (TN) type. However, it is not limited thereto and a driving type of the liquid crystal panel may be an in-plane switching (IPS) type, a multi-domain vertical alignment (MVA) type, or a fringe field switching (FFS) type.

(6) In each of the above embodiments, the liquid crystal display device and the method producing thereof are described. However, it is not limited thereto and display devices other than a liquid crystal display device may be included in a scope of the present invention. For example, a method of producing an organic EL display device may be included in a scope of the present invention.

The embodiments of the present invention are described in detail. However, the present invention is not limited to the embodiments. Modifications or altered modes of the embodiments described above are also included in the technical scope of the present invention.

### EXPLANATION OF SYMBOLS

1, 501, 601, 701: Liquid crystal display device, 10, 110, 210, 310, 410, 510, 610, 710: Liquid crystal panel, 12, 112, 212, 312, 412, 512, 612, 712: Flexible circuit board, 18: Liquid crystal layer, 20, 720: Color filter board, 20A: First glass substrate, 22: Color filter, 23: Light blocking section, 22A: Most outer edge-side display pixel, 22B: Other display pixels, 24: Counter electrode, 30, 130, 230, 330, 430, 530, 730: Array board, 30A, 130A, 230A, 530A, 730A: Second glass substrate, 30A1, 130A1, 230A1, 530A1, 630A1, 730A1: recess, 30L: Thin film patterns, 32: TFT, 32D: Drain electrodes, 32G: Gate electrodes, 32S: Source electrodes, 34: Pixel electrodes, 36G: Gate lines, 37: Semiconductor film, 38G, 338G, 438G: Gate insulator film, 40: Sealant, 44: Scriber, 336G1, 436G1: First gate lines, 336G2: Second gate lines, 336G3: Third gate lines, 436G4: Fourth gate lines, 512S: Through hole, 530A2: Projection portion, 750: Controller, 752: Correcting section, A1: Display area, A2: Non-display area, CH1: First contact hole, CH2: Second contact hole, CH3: Third contact hole, CH4: Fourth contact hole, H1: Hole, RF1: Resist film, S1, S2: Gap

1. A method of producing a display device comprising:
a recess forming process of forming a recess in one section of a first substrate;
a resin film forming process of forming a resin film having flexibility within the recess after the recess forming process;
a metal line forming process of forming metal lines continuously on another section of the first substrate and the resin film after the resin film forming process;
a pattern forming process of forming thin film patterns on the other section of the first substrate;
a bonding process of disposing sealant on the first substrate to surround the thin film patterns and bonding the first substrate and a second substrate opposite each other with the sealant after the pattern forming process;
a second substrate removing process of removing a section of the second substrate outside the sealant after the bonding process; and
a first substrate removing process of separating and removing at least a section of the first substrate outside the sealant from the resin film after the bonding process.

2. The method of producing a display device according to claim 1, wherein in the resin film forming process, the resin film is formed within the recess such that an upper surface of the first substrate is flush with an upper surface of the resin film.

3. The method of producing a display device according to claim 1, further comprising:
a folding process of folding at least a section of the resin film projecting outside the recess toward an opposite side from the second glass substrate after the first substrate removing process, wherein
in the folding process, the section of the resin film is folded while providing a gap between an end surface of the first substrate and a folded section of the resin film.

4. The method of producing a display device according to claim 3, wherein in the folding process, the section of the resin film is folded such that the folded section of the resin film overlaps the sealant in a thickness direction of the first substrate.

5. The method of producing a display device according to claim 1, wherein
in the recess forming process, a projection portion projecting in a thickness direction of the first substrate is formed within the recess, and
in the resin film forming process, a through hole through which the projection portion is inserted is formed in a part of the resin film.

6. The method of producing a display device according to claim 1, wherein
in the recess forming process, the recess is formed along an entire periphery of an edge of the first substrate.

7. A display device comprising:
a display panel including substrates a pair that are bonded with sealant, the display panel performing displaying;
a flexible circuit board having flexibility and a section of which is disposed in one of the substrates, the section disposed in the one substrate including a portion overlapping the sealant in a thickness direction of the substrates between the substrates; and
metal lines formed continuously on the one substrate and the flexible circuit board and through which signals for driving the display panel are transmitted.

8. The display device according to claim 7, Wherein
the display panel includes a display area and a non-display area within a panel surface area, the display area displaying images and the non-display area displaying no images, and
the section of the flexible circuit board disposed in the one substrate is only in a section of the flexible circuit hoard overlapping the non-display area in a thickness direction of the substrates.

9. The display device according to claim 7, wherein
the display panel includes a display area and a non-display area within a panel surface area, the display area displaying images and the non-display area displaying no images,
the display device further comprises a controller configured to control brightness of the images on the display area,
the other substrate includes a light blocking section that has light blocking properties and is formed in a grid and color sections that are formed in sections surrounded by the light blocking section, and the color sections formed in the sections have different colors, and a combination of the color sections of different colors forms a display pixel,
a most inner-side portion of the section of the flexible circuit board that is disposed in the recess overlaps a most outer edge-side one of display pixels within the display area in the thickness direction of the substrates, and
the controller includes a correcting section configured to correct the images such that the display pixels on the outermost side within the display area are displayed brighter than other display pixels.
